(19) United States
(12) Patent Application Publication
(10) Pub. No.: US 2025/0211370 A1
(43) Pub. Date: Jun. 26, 2025

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventors: Yiwei DENG, Shenzhen, Guangdong (CN); Jia SHENG, Shenzhen, Guangdong (CN)

(73) Assignee: SHENZHEN TCL NEW TECHNOLOGY CO., LTD., Shenzhen, Guangdong (CN)

(21) Appl. No.: 18/848,906

(22) PCT Filed: Apr. 6, 2022
(86) PCT No.: PCT/CN2022/085415

§ 371 Date: Sep. 19, 2024

(51) Int. Cl. H04L 1/1822; H04W 72/1263; H04W 72/232; H04W 76/28

(52) U.S. Cl. CPC H04L 1/1822; H04W 72/1263; H04W 72/232; H04W 76/28

(57) ABSTRACT

A wireless communication method and related devices are provided. The method, performed by a user equipment (UE), including being configured with a fixed transmission pattern within a periodicity, wherein the transmission pattern comprises multiple CG/SPS configurations within the periodicity; determining HARQ-ID of each of the CG/SPS configurations within the periodicity for estiblishing identity of each of the CG/SPS configurations for HARQ, wherein the HARQ-ID of remaining CG/SPS configurations except a first CG/SPS configuration appeared first in the periodicity is determined based on the HARQ-ID of the first CG/SPS configuration within the periodicity and one or more values of a configured, pre-configured or pre-defined setting. With this method, HARQ-ID of each of the CG/SPS configurations is determined.

### TECHNICAL FIELD

The present application relates to wireless communication technologies, and more particularly, to wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

EXtended Reality (XR) and Cloud Gaming are some of the most important 5G media applications under consideration in the industry. XR is an umbrella term for different types of realities and refers to all real-and-virtual combined environments and human-machine interactions generated by computer technology and wearable devices. It includes representative forms such as Augmented Reality (AR), Mixed Reality (MR) and Virtual Reality (VR) and the areas interpolated among them. A new Study Item Description (SID) on XR evaluation has been approved, the characteristics of XR traffic and challenges are summarized below:

High Data Rate with Limited Latency

For 3D VR videos with high resolution based on different frame rates, color codecs, bit-depths, compression rates and etc., the transmission date rate could be up to 60 Mbps and above with limited latency, around 10-30 ms.

Non-Integer Period with Jitter

It has been agreed that 60 frames per second (fps) is baseline for both Downlink (DL) and Uplink (UL) video stream and 30 fps, 90 fps as well as 120 fps can be also optionally evaluated. Based on the formula of arrival time of packet, the corresponding periodicities are {33.33 ms, 16.67 ms, 11.11 ms, 8.33 ms}. In addition, there exists jitter characteristic for XR traffic arrival. According to RAN1 agreements, the jitter can be modeled as truncated Gaussian distribution with varying range of [−4,4] ms (baseline) or [−5,5] ms (optional).

### Varying Frame Size

In the field of video compression, three major frame types are defined through three different video algorithms with the following characteristics:
I-frames are the least compressible which can decode independently
P-frames can use previous frames to decompress and are more compressible than I-frames.
B-frames can use both previous and forward frames to get the highest amount of data compression.

There is a need to solve the problems raised when merging the XR services into cellular wireless communication, especially for XR service transmission in New Radio (NR).

### SUMMARY

The objective of the present application is to provide a wireless communication method and related devices for enhancing service traffic such as EXtended Reality (XR) service transmission.

In a first aspect, an embodiment of the present application provides a wireless communication method, performed by a user equipment (UE) in a network, the method including: being configured with a fixed transmission pattern within a periodicity, wherein the transmission pattern includes multiple Configured Grant (CG)/Semi-Persistent Scheduling (SPS) configurations within the periodicity; and determining Hybrid Automatic Repeat reQuest (HARQ)-ID of each of the CG/SPS configurations within the periodicity for estiblishing identity of each of the CG/SPS configurations for HARQ, wherein the HARQ-ID of remaining CG/SPS configurations except a first CG/SPS configuration appeared first in the periodicity is determined based on the HARQ-ID of the first CG/SPS configuration within the periodicity and one or more values of a configured, pre-configured or pre-defined setting.

In a second aspect, an embodiment of the present application provides a wireless communication method, performed by a user equipment (UE) in a network, the method including: being configured with Discontinuous Reception (DRX) and/or Semi-Persistent Scheduling (SPS)/Configured Grant (CG) transmission occasions; being configured with a Physical Downlink Control Channel (PDCCH) monitor occasion after each of the SPS/CG transmission occasions; and monitoring PDCCH on the PDCCH monitor occasion when a Physical Downlink Shared Channel (PDSCH) or Physical Uplink Shared Channel (PUSCH) is received or transmitted on a corresponding SPS/CG transmission occasion.

In a third aspect, an embodiment of the present application provides a wireless communication method, performed by a user equipment (UE) in a network, the method including: being configured with Discontinuous Reception (DRX) with a DRX-ON time duration for Physical Downlink Control Channel (PDCCH) monitoring or receiving data or transmitting data in a Time Division Duplex (TDD) or Frequency Division Duplex (FDD) deployment scenario, wherein the DRX-ON duration is determined by a timer, and the timer counts based on available time or slot.

In a fourth aspect, an embodiment of the present application provides a wireless communication method, performed by a user equipment (UE) in a network, the method including: transmitting a buffer status to a base station (BS) with an index indicating a specific range of buffer size and an enhanced buffer status reporting (BSR) indication indicating one of a plurality of sub-ranges of the specific range of buffer size, wherein the specific range of buffer size is divided into the plurality of sub-ranges.

In a fifth aspect, an embodiment of the present application provides a wireless communication method, performed by a base station (BS) in a network, the method including: configuring a user equipment (UE) with a fixed transmission pattern within a periodicity, wherein the transmission pattern includes multiple Configured Grant (CG)/Semi-Persistent Scheduling (SPS) configurations within the periodicity; and configuring or pre-configuring a setting for the UE to determine Hybrid Automatic Repeat reQuest (HARQ)-ID of each of the CG/SPS configurations within the periodicity for estiblishing identity of each of the CG/SPS configurations for HARQ, wherein the HARQ-ID of remaining CG/SPS configurations except a first CG/SPS configuration appeared first in the periodicity is determined based on the HARQ-ID of the first CG/SPS configuration within the periodicity and one or more values of the setting.

In a sixth aspect, an embodiment of the present application provides a wireless communication method, performed by a base station (BS) in a network, the method including: configuring a user equipment (UE) with Discontinuous Reception (DRX) and/or Semi-Persistent Scheduling (SPS)/Configured Grant (CG) transmission occasions; and configuring the UE with a Physical Downlink Control Channel (PDCCH) monitor occasion after each of the SPS/CG transmission occasions; and configuring the UE to monitor PDCCH on the PDCCH monitor occasion when a Physical Downlink Shared Channel (PDSCH) or Physical Uplink Shared Channel (PUSCH) is received or transmitted on a corresponding SPS/CG transmission occasion.

In a seventh aspect, an embodiment of the present application provides a wireless communication method, performed by a base station (BS) in a network, the method including: configuring a user equipment (UE) with Discontinuous Reception (DRX) with a DRX-ON time duration for Physical Downlink Control Channel (PDCCH) monitoring or receiving data or transmitting data in a Time Division Duplex (TDD) or Frequency Division Duplex (FDD) deployment scenario, wherein the DRX-ON duration is determined by a timer, the timer counts based on available time or slot.

In an eighth aspect, an embodiment of the present application provides a wireless communication method, performed by a base station (BS) in a network, the method including: receiving a buffer status from a user equipment (UE) with an index indicating a specific range of buffer size and an enhanced buffer status reporting (BSR) indication indicating one of a plurality of sub-ranges of the specific range of buffer size, wherein the specific range of buffer size is divided into the plurality of sub-ranges.

In a ninth aspect, an embodiment of the present application provides a UE, including a processor configured to call and run program instructions stored in a memory, to execute the method of any of the first, the second, the third or the fourth aspect.

In a tenth aspect, an embodiment of the present application provides a BS, including a processor configured to call and run program instructions stored in a memory, to execute the method of any of the fifth, the sixth, the seventh or the eighth aspect.

In an eleventh aspect, an embodiment of the present application provides a computer readable storage medium provided for storing a computer program, which enables a computer to execute the method of any of the first to the eighth aspects.

In a twelfth aspect, an embodiment of the present application provides a computer program product, which includes computer program instructions enabling a computer to execute the method of any of the first to the eighth aspects.

In a thirteenth aspect, an embodiment of the present application provides a computer program, when running on a computer, enabling the computer to execute the method of any of the first to the eighth aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic block diagram illustrating a communication network system according to an embodiment of the present application.

FIG. 2 is a schematic diagram illustrating a transmission pattern within a periodicity.

FIG. 3 is a flowchart of a wireless communication method according to a first embodiment of the present application.

FIG. 4 is a schematic diagram illustrating an example of HARQ-ID for CG/SPS according to an embodiment of the present application.

FIG. 5 is a schematic diagram illustrating another example of HARQ-ID for CG/SPS according to an embodiment of the present application.

FIG. 6 is a schematic diagram illustrating Discontinuous Reception (DRX) with CG/SPS.

FIG. 7 is a flowchart of a wireless communication method according to a second embodiment of the present application.

FIG. 8 is a schematic diagram illustrating an example of PDCCH monitoring after CG/SPS according to an embodiment of the present application.

FIG. 9 is a schematic diagram illustrating another example of PDCCH monitoring after CG/SPS according to an embodiment of the present application.

FIG. 10 is a schematic diagram illustrating DRX-on duration in TDD or FDD deployment scenario based on absolute time.

FIG. 11 is a flowchart of a wireless communication method according to a third embodiment of the present application.

FIG. 12 is a schematic diagram illustrating DRX-on duration in TDD or FDD deployment scenario based on available time according to an embodiment of the present application.

FIG. 13 is a flowchart of a wireless communication method according to a fourth embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

Following issues are identified for service traffic such as EXtended Reality (XR) service transmission.

It has been agreed that 60 frames per second (fps) is baseline for both DL and UL video stream and 30 fps, 90 fps as well as 120 fps can be also optionally evaluated. Based on the formula of arrival time of packet, the corresponding periodicities are {33.33 ms, 16.67 ms, 11.11 ms, 8.33 ms}. In current spec, supported semi-persistent scheduling (SPS) periods are {10 ms, 20 ms, 32 ms, . . . , 640 ms}, {1 ms, 2 ms, . . . , 640 ms} for subcarrier spacing of 15 kHz, 0.5×{1 ms, 2 ms, . . . , 1280 ms} for subcarrier spacing of 30 kHz, 0.25×{1 ms, 2 ms, . . . , 2560 ms} for subcarrier spacing of 60 kHz and 0.125×{1 ms, 2 ms, . . . , 5120 ms} for subcarrier spacing of 120 kHz, and supported configured grant (CG) periods are { 1/7 ms, 0.5 ms, 1 ms, . . . , 320 ms, 640 ms} for subcarrier spacing of 15 kHz, 0.5×{ 1/7 ms, 0.5 ms, 1 ms, . . . , 1280 ms} for subcarrier spacing of 30 kHz, 0.25×{ 1/7 ms, 0.5 ms, 1 ms, . . . , 2560 ms} for subcarrier spacing of 60 kHz. However, the periodicity of XR/CG and periodicity of SPS/CG are not matched.

In addition, there exists jitter characteristic for XR traffic arrival. However, the periodicity of SPS in current specification can only be an integer number of slots, there is a gap between XR services arrival and semi-persistent scheduling (SPS) periodicity, and configured grants have similar problem.

As a result, in RAN1 meeting, some potential methods to solve the problem were proposed, that is, Alt 1, introducing a time offset for CG/SPS; Alt2, configuring a CG/SPS transmission pattern. Compared with alt1, alt2 is more flexible. When a CG/SPS transmission pattern is configured, Hybrid Automatic Repeat request (HARQ)-ID for CG/SPS within the transmission pattern should be studied.

Furthermore, Discontinuous Reception (DRX) is one of the efficient methods for UE power saving. When a UE steps into a DRX-OFF state, it will be suspended from Physical Downlink Control Channel (PDCCH) monitoring and may go to sleep for UE power saving. In current 3GPP spec, UE is required to monitor Physical Downlink Shared Channel (PDSCH) at a configured SPS occasion regardless of whether it is at DRX ON or OFF state when DRX is configured. According to discussion on traffic model, mean packet size is very large. Taking AR/VR 60 Mbps for example, its mean packet size is 125000 bytes. To transmit so large Transport Block Size (TBS), more than one slot in time domain are needed. When DRX and SPS/CG are configured, a packet arrived before SPS/CG cannot be transmitted completely on a SPS/CG transmission occasion. A large latency will be caused if the UE waits for scheduling until DRX on-duration. Some enhancement methods to solve this problem will be needed.

DRX is one of the efficient methods for UE power saving. When a UE steps into a DRX-OFF state, it will be suspended from PDCCH monitoring and may go to sleeping for UE power saving. In current 3GPP spec, the C-DRX timers are controlled by absolute time duration. However, for Time Division Duplex (TDD) or Frequency Division Duplex (FDD) deployment scenarios, the absolute time duration for DRX is not suitable for XR services due to large traffic load and sensitive latency. Some enhancement methods to solve this problem will be needed.

Moreover, for XR services, a large buffer will be generated, and this results in having to create buffer Status reporting (BSR) indexes higher than that in the existing BSR tables. The higher the BSR index, the larger the inaccuracy of buffer status. This is since the BSR index indicates a range of values between X and Y, and the difference between X and Y is large. An enhancement method for this issue will be needed.

The invention of this disclosure can be summarized as below:
1. When a CG (Configured Grant)/SPS (Semi-Persistent Scheduling) transmission pattern is configured, the HARQ (Hybrid Automatic Repeat reQuest)-ID for CG/SPS within the transmission pattern should be studied.
   The HARQ-ID for the first CG/SPS configuration within a periodicity is determined based on current mechanism, and a default value is specified to determine the HARQ-ID of remaining CG/SPS within the periodicity.
   The HARQ-ID for the first CG/SPS configuration within a periodicity is determined based on current mechanism, and a set of HARQ-ID offset is configured to determine the HARQ-ID of remaining CG/SPS within the periodicity.
2. When DRX (Discontinuous Reception) and SPS/CG is configured and a packet is arrived before SPS/CG, a SPS/CG transmission occasion cannot transmit the packet completely. A large latency will be caused if the UE waits for scheduling until DRX-ON state. Some enhancement methods to solve this problem will be needed.
   A PDCCH (Physical Downlink Control Channel) monitor occasion is configured to UE right after the SPS/CG transmission occasion. When a SPS/CG is received, UE needs to monitor PDCCH; otherwise, UE go sleeping.
   UE needs to monitor PDCCH after SPS when a PDSCH on the SPS is received, and predefined location and resources (search space and Control Resource Set (CORESET)) are used for UE to monitor PDCCH.
   UE need to monitor PDCCH after SPS when a PDSCH on a SPS is received, and configured parameters of the nearest received DCI (Downlink Control Information) could be reused for the PDCCH monitoring.
3. For TDD (Time Division Duplex) or Frequency Division Duplex (FDD) deployment scenario, an absolute time duration for DRX is not suitable for XR services due to its large traffic load and sensitive latency. Some enhancement methods to solve this problem will be needed.
   drx-onDurationTimer is counted based on available time or slot.
   drx-onDurationTimer is counted based on available time or slot, and some reserved states of DRX-onDurationTimer could be used for indicating the drx-onDurationTimer based on the available time or slot.
4. For XR services, a large buffer will be generated, and this results in having to create BSR (Buffer State Report) indexes higher than that in the existing BSR tables. The higher the BSR index, the larger the inaccuracy of buffer status. This is since the BSR index indicates a range of values between X and Y, and the difference between X and Y is large. An enhancement method for this issue will be needed.
   A new field should be introduced in MAC CE (Media Access Control Control Element) for BSR, and the new field indicates a range of values between X and Y.

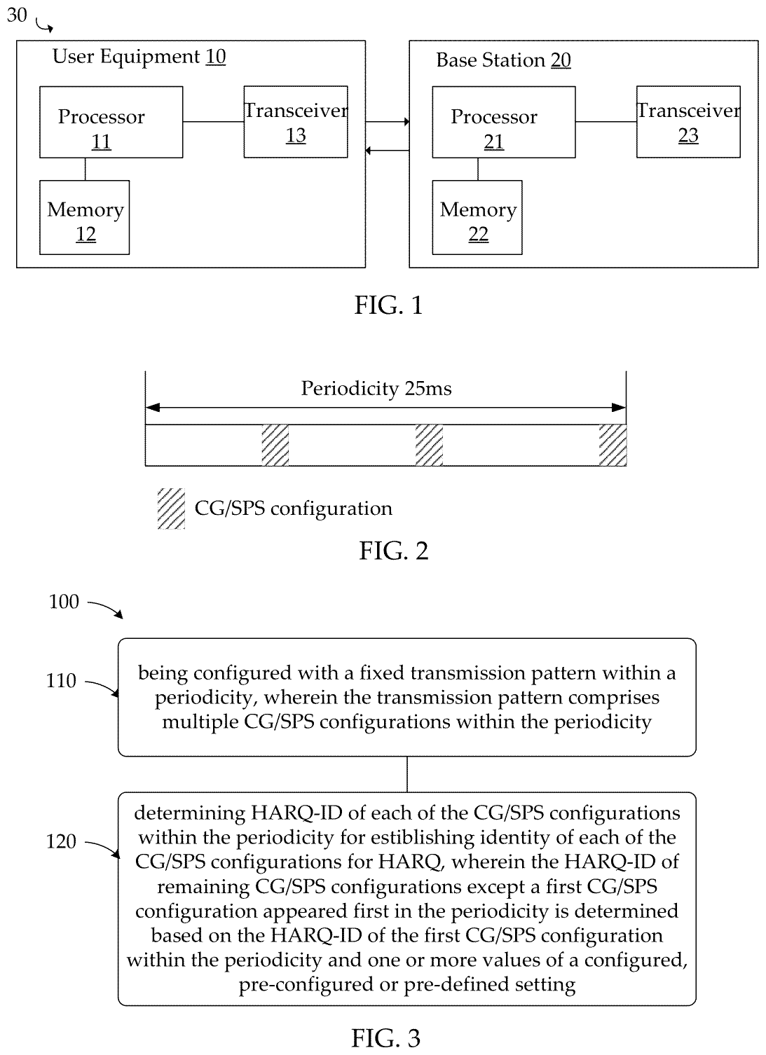

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

This disclosure proposes a method to determine the HARQ-ID for SPS and CG when a transmission pattern is configured for XR services.

SPS/CG is configured to UE for periodic traffic or time-sensitive traffic. However, for XR services, it has been agreed that 60 frames per second (fps) is baseline for both Downlink (DL) and Uplink (UL) video stream and 30 fps, 90 fps as well as 120 fps can be also optionally evaluated, which mismatches current periodicity of SPS/CG. A straightforward way is to introduce some new periodicity values for SPS/CG, e.g., 25 ms, 50 ms, 100 ms. If the new periodicity is introduced, it means N integer transmission occasions within a new periodicity can be matched to XR service. Take 25 ms periodicity as an example, if XR services traffic arrival rate is 120 frames per second, then 3 frames are arrived within 25 ms periodicity. So configured transmission pattern within a periodicity for XR services could be considered, where a transmission pattern includes multiple SPS/CG with a fixed pattern within the periodicity are configured, as shown in FIG. 2.

In 3GPP Rel-16, multiple CG/SPS are introduced for reducing alignment time delay for sensitive traffic and different QoS services. However, for XR services, the CG/SPS is used for transmission of similar packets, with current multiple CG/SPS configured mechanism, and thus the overhead is large. A simple way is to share all of the parameters but CG/SPS configured index. In addition, a transmission pattern index should be configured for the transmission pattern within a periodicity, where the index is used to identify the transmission pattern, and the value of the index is configurable and can be configured by RRC signaling.

If the transmission pattern within a periodicity is adopt for XR services, then the HRAQ-ID for each CG/SPS within a periodicity should be studied. In current 3GPP spec, for a SPS/CG configuration without repetition, the HARQ-ID of the SPS/CG within a periodicity is determined based on the first symbol of the CG/SPS within the periodicity and is calculated using an equation. When multiple CG/SPS within a periodicity are configured, the following ways to determine HARQ-ID can be considered.

FIG. 3 is a flowchart of a wireless communication method according to a first embodiment of the present application. Referring to FIG. 3 in conjunction with FIG. 1, the method 100 includes the following. In Step 110, the UE 10 is configured with a fixed transmission pattern within a periodicity, wherein the transmission pattern includes multiple CG/SPS configurations within the periodicity. In Step 120, the UE 10 determines HARQ-ID of each of the CG/SPS configurations within the periodicity for estiblishing identity of each of the CG/SPS configurations for HARQ, wherein the HARQ-ID of remaining CG/SPS configurations except a first CG/SPS configuration appeared first in the periodicity is determined based on the HARQ-ID of the first CG/SPS configuration within the periodicity and one or more values of a configured, pre-configured or pre-defined setting. With this method, HARQ-ID for estiblishing identity of each of the CG/SPS configurations for HARQ is determined for XR services.

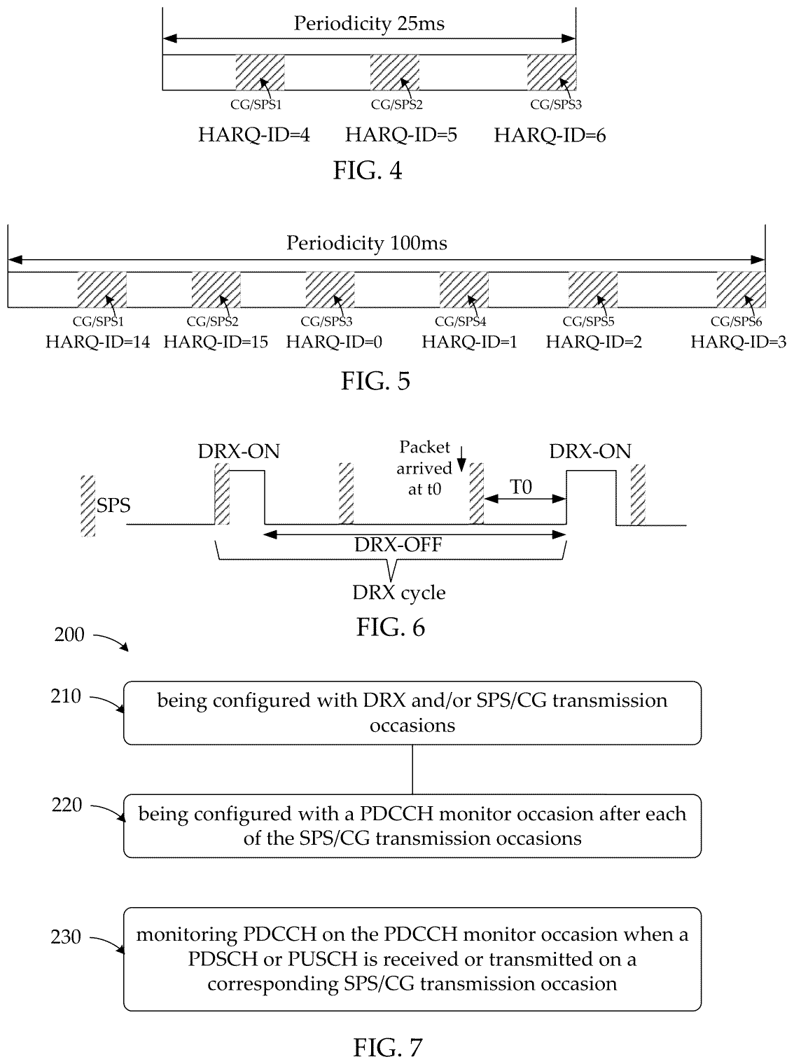

In a first possible implementation, the HARQ-ID for the first CG/SPS configuration within a periodicity is determined based on current mechanism (as specified in TS 38.211, for example), and a default value (the default value is an integer) is specified to determine HARQ-ID of the remaining CG/SPS within the periodicity. Identity of each of the SPS/CG configurations within the periodicity is established for HARQ as such. The default value is configured or pre-configured by the base station or pre-defined in the user equipment. More specifically, a HARQ-ID of the CG/SPS except the first one within the periodicity is determined based on [(default value) adds (the HARQ-ID of nearest previous CG/SPS)] modulo nrofHARQ-Processes, where nrofHARQ-Processes is the number of HARQ process. Take a 25 ms periodicity with 3 CG/SPS as an example. The number of HARQ processes is configured as 16, and the default value is defined as 1. Based on the equation in 3GPP Rel-16, the HARQ-ID of the CG/SPS 1 within a periodicity is 4, and then the HARQ-ID of CG/SPS 2 is: ((HARQ-ID of CG/SPS 1+1) mod 16=5), and the HARQ-ID of CG/SPS 3 is: ((HARQ-ID of CG/SPS 2+1) mod 16=6), as shown in FIG. 4.

Take a 100 ms periodicity with 6 CG/SPS as another example. The number of HARQ processes is configured as 16, and the default value is defined as 1. Based on the equation in 3GPP Rel-16, the HARQ-ID of the CG/SPS 1 within a periodicity is 14, and then the HARQ-ID of CG/SPS 2 is: ((HARQ-ID of CG/SPS 1+1) mod 16=15), the HARQ-ID of CG/SPS 3 is: ((HARQ-ID of CG/SPS 2+1) mod 16=0), the HARQ-ID of CG/SPS 4 is: ((HARQ-ID of CG/SPS 3+1) mod 16=1), the HARQ-ID of CG/SPS 5 is: ((HARQ-ID of CG/SPS 4+1) mod 16=2), the HARQ-ID of CG/SPS 6 is: ((HARQ-ID of CG/SPS 5+1) mod 16=3), as shown in FIG. 5. The default value can be any appropriate integer value as long as each of the CG/SPS configurations within the periodicity can be identified for HARQ.

In a second possible implementation, the HARQ-ID for the first CG/SPS configuration within a periodicity is determined based on current mechanism (as specified in TS 38.211, for example), and a set of HARQ-ID offsets are configured to determine HARQ-ID of remaining CG/SPS within the periodicity, where the number of the set of HARQ-ID offsets is equal to the number of CG/SPS configurations within the periodicity minus 1. Identity of each of the SPS/CG configurations within the periodicity is established for HARQ as such. The default value is configured or pre-configured by the base station or pre-defined in the user equipment. More specifically, the HARQ-ID of a CG/SPS is equal to: [(HARQ-ID of the first CG/SPS configuration) plus (corresponding HARQ-ID offset value)] modulo nrofHARQ-Processes, where the corresponding HARQ-ID offset value means a value corresponding to a CG/SPS configuration, e.g., the second CG/SPS configuration corresponding to the first value in the set of HARQ-ID offsets, the third CG/SPS configuration corresponding to the second value of the set of HARQ-ID offsets, same way for the remaining CG/SPS configurations. For instance, the number of HARQ processes is configured as 16, the set of HARQ-ID offsets are configured as {2, 3}. Based on the equation in 3GPP Rel-16, the HARQ-ID of the first CG/SPS within a periodicity is 4, and then the HARQ-ID of the second CG/SPS is equal to: (4+2) mod 16=6, and the HARQ-ID of the third CG/SPS is equal to: (4+3) mod 16=7. The set of HARQ-ID offsets can be formed by any appropriate integer value as long as each of the CG/SPS configurations within the periodicity can be identified for HARQ.

In some embodiments, the default value or the set of HARQ-ID offsets are configured by RRC signaling.

In some embodiments, for CG, the default value or the set of HARQ-ID offsets are configured by ConfiguredGrantConfig.

In some embodiments, for SPS, the default value or the set of HARQ-ID offsets are configured by SPS-Config.

In some embodiments, there is only one HARQ-ID offset value or all of HARQ-ID offset values in the set of HARQ-ID offsets are identical to each other (this is similar to the default value mentioned above, and then the HARQ-ID of CG/SPS determined based on above-described method.

Low power consumption is important for various types of devices used for XR applications and Could Gaming, e.g. smart glasses, smartphones, and tablets. DRX is one of the efficient methods for UE power saving. When a UE steps into a DRX-OFF state, it will be suspended from Physical Downlink Control Channel (PDCCH) monitoring and may go to sleep for UE power saving. In current 3GPP spec, UE is required to monitor Physical Downlink Shared Channel (PDSCH) at a configured SPS occasion regardless of whether it is at DRX ON or OFF state when DRX is configured. When a UE is configured with DRX, the UE only monitors PDCCH in DRX-ON state. Assuming that a UE is configured with DRX and CG/SPS configurations, when the UE is in DRX-OFF state and there is a large Transport Block (TB) arrived before a SPS transmission occasion, then gNB could use the SPS to transmit the TB. Due to the large-sized TB, the SPS resource can only transmit a part of the TB, a remaining part of the TB needs to postpone until the UE turns to DRX-ON. However, large alignment delay will be caused. For instance, as shown in FIG. 6, a packet arrived at t0 and at this time UE is on the state of DRX-OFF, a SPS resource cannot transmit all of the packet and then the remaining part of the packet has to be scheduled at least after TO.

To solve this problem, the following methods can be considered.

FIG. 7 is a flowchart of a wireless communication method according to a second embodiment of the present application. Referring to FIG. 7 in conjunction with FIG. 1, the method 200 includes the following. In Step 210, the UE 10 is configured with DRX and/or SPS/CG transmission occasions. In Step 220, the UE 10 is configured with a PDCCH monitor occasion after each of the SPS/CG transmission occasions. In Step 230, the UE 10 monitors PDCCH on the PDCCH monitor occasion when a Physical Downlink Shared Channel (PDSCH) or Physical Uplink Shared Channel (PUSCH) is received or transmitted on a corresponding SPS/CG transmission occasion. With this method, latency is improved for XR services.

In a first possible implementation, for DRX, a PDCCH monitor occasion is configured to UE right after the SPS/CG transmission occasion. When a SPS/CG is received, UE needs to monitor PDCCH; otherwise, UE goes sleeping.

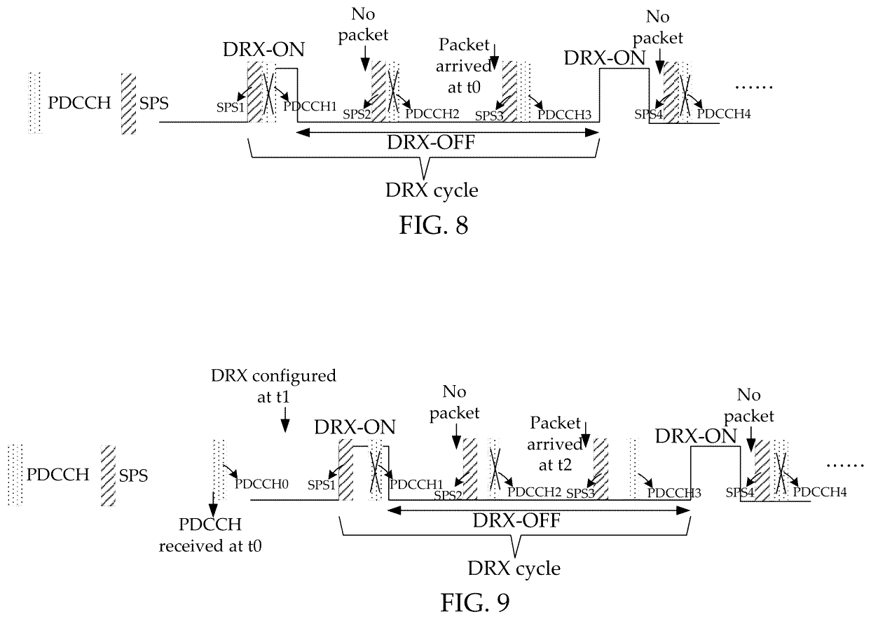

Take SPS as an example, as shown in FIG. 8, there is a PDCCH configured after a SPS transmission occasion. A packet is arrived before sps3 and gNB transmits a PDSCH on sps3 (where sps3 just means a SPS transmission occasion), and then UE needs to monitor pdcch 3 (where pdcch 3 just means a PDCCH monitor occasion). There is no PDSCH transmitted on sps2 and sps4, so the UE needn't to monitor PDCCH on pdcch2 and pdcch4.

In some embodiments, the UE needs to skip monitoring the PDCCH during the DRX-ON state even though the PDSCH is received on corresponding SPS.

In some embodiments, a common search space or a UE-specific search space can be configured to the UE for PDCCH monitoring.

In a second possible implementation, for DRX, UE needs to monitor PDCCH after SPS/CG when a PDSCH/PUSCH on the SPS/CG is received, and predefined location and resources (search space and Control Resource Set (CORESET)) are used for UE to monitor PDCCH, e.g., the start symbol and duration within a slot for the PDCCH monitoring, and the frequency resources for the PDCCH monitoring. SPS is taken as an example for following descriptions.

In some embodiments, the PDCCH monitor occasion is located at a slot or available slot next to the SPS.

In some embodiments, the PDCCH monitor occasion is located at one or more slots next to the SPS, where the symbol of PDCCH is not overlapped with the SPS.

In some embodiments, a time offset (unit of slot or symbol or ms) can be configured to UE for the PDCCH monitor occasion, where the location of the PDCCH is within (slot i plus offset value), where slot i is the slot on which the SPS or PDSCH transmits.

In some embodiments, a time offset (unit of slot or symbol or ms) can be configured to UE for PDCCH monitor occasion, where the location of the PDCCH starts at (symbol i plus the offset value), where symbol i is the last symbol of the SPS or PDSCH transmission.

In a third possible implementation, for DRX, UE needs to monitor PDCCH after SPS/CG when a PDSCH/PUSCH on the SPS/CG is received, and the configured parameters of the nearest received Downlink Control Information (DCI) could be reused for the PDCCH monitoring. In other words, the search space and coreset of the lastest received DCI can be used for PDCCH monitoring. SPS is taken as an example for following descriptions. For instance, as shown in FIG. 9, pdcch 0 is the lastest PDCCH received by UE before DRX configuration, and then UE knows the configured parameters (e.g., search space and CORESET, etc.) of the pdcch 0. When a packet arrives at to and gNB transmits PDSCH on sps 3, then UE needs to monitor pdcch 3, where pdcch 3 is located after sps 3 and is determined based on search space and CORESET of pdcch 0. That is, location and resources for the PDCCH monitor occasion under DRX is determined based on the configured parameters received before DRX configuration.

In some embodiments, the above methods can also be applied to a scenario only configured with CG/SPS without DRX. That is, when a PDSCH is received by UE on a SPS transmission occasion or a PUSCH is transmitted on a CG by UE, then UE needs to monitor PDCCH after SPS/CG based on above methods.

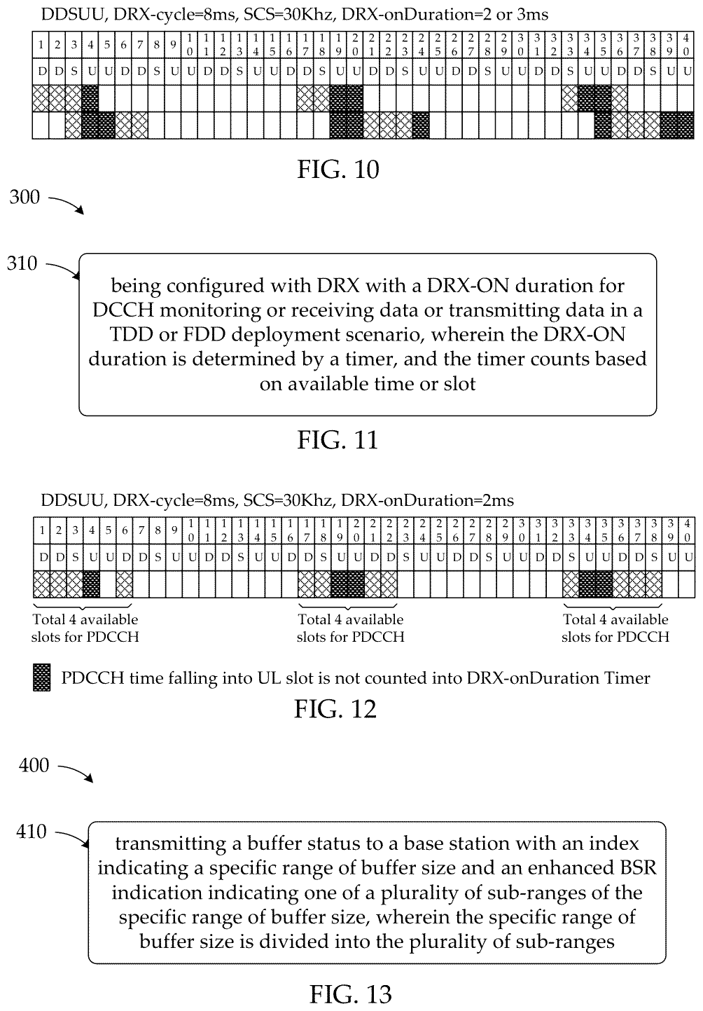

Low power consumption is important for various types of devices used for XR applications and Could Gaming, e.g. smart glasses, smartphones, and tablets. DRX is one of the efficient methods for UE power saving. When a UE steps into a DRX-OFF state, it will be suspended from PDCCH monitoring and may go to sleep for UE power saving. In current 3GPP spec, DRX-onDurationTimer is an absolute time period, e.g., 1 ms, 2 ms, 3 ms, 4 ms, etc. However, it will be not suitable for TDD or FDD deployment scenarios. In a TDD or FDD case, there may be the case that during the running DRX timer, some PDCCH monitor occasions will fall into UL slots. Hence, UE will have less opportunity to monitor PDCCH during the DRX-ON state. As a result, latency requirement for the traffic may not be guaranteed. For instance, it is assumed that the frame structure is DDSUU, DRX cycle is 8 ms, Subcarrier Spacing (SCS) is 30 Khz, and DRX-on duration is 2 ms or 3 ms. As shown in FIG. 10, there are slots of PDCCH monitor occasions that fall into UL slots (highlighted with black dots).

A way to guarantee the number of PDCCH monitor occasions should be studied. The following methods could be considerated.

FIG. 11 is a flowchart of a wireless communication method according to a third embodiment of the present application. Referring to FIG. 11 in conjunction with FIG. 1, the method 300 includes the following. In Step 310, the UE 10 is configured with DRX with a DRX-ON duration for DCCH monitoring or receiving data or transmitting data in a TDD or FDD deployment scenario, wherein the DRX-ON duration is determined by a timer, and the timer counts based on available time or slot.

In a first possible implementation, drx-onDurationTimer for determining the DRX-ON duration counts based on available time or slot (part of drx-onDurationTimer or slot collided with other transmission (transmission direction) is not counted into a total amount of time duration by the drx-onDurationTimer when the timer is running), where the available time or slot is determined semi-static. For instance, it is assumed that the frame structure is DDSUU, DRX cycle is 8 ms, SCS is 30 Khz, and DRX-on duration is 2 ms. As shown in FIG. 12, there are slots of PDCCH monitor occasions that fall into UL slots (highlighted with black dots), and these are not counted by the DRX-onDurationTimer, and corresponding supplement slots will be added for PDCCH monitoring.

In some embodiments, at least one parameter of tdd-UL-DL-ConfigurationCommon or tdd-UL-DL-ConfigurationDedicated or ssb-PositionslnBurst is considered for semi-static determination of available slot for drx-onDurationTimer. If at least one symbol of PDCCH within a slot during the DRX-ON duration is overlapped with UL slot or other transmission, the slot within drx-onDurationTimer is not an available slot.

In some embodiments, the other transmission can be a downlink transmission with higher priority or a UL transmission.

In some embodiments, the UE can go sleeping on the slots which are not available during the DRX-ON state when available timer is used for DRX-onDurationTimer.

When available time or slot is considered for drx-onDurationTimer, one issue has to be considered, that is, how to distinguish a legacy UE and an enhanced UE (the legacy UE is on behalf on R-15/16/17 or the UE with absolute drx-onDurationTimer; the enhanced UE is on behalf of the UE with the afore-described drx-onDurationTimer based on available time or slot). One simple way is to introduce a RRC signalling to indicate the UE, for example, an information element (IE) configured in DRX-Config Information element. The parameter availableforDRX configured as “enabled” means DRX-onDurationTimer is based on available time, and the parameter availableforDRX configured as “disabled” means DRX-onDurationTimer is based on absolute time (that is, legacy mechanism), as shown below:

-- ASN1START
-- TAG-DRX-CONFIG-START
AvailableforDRX ENUMERATED {enabled, diabled}

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, ms50, ms60, |
| | ms80, ms100, ms200, ms300, ms400, ms500, ms600, ms800, ms1000, ms1200, |
| | ms1600, spare8, spare7, spare6, spare5, spare4, spare3, spare2, spare1 } |
| | }, |
| drx-InactivityTimer | ENUMERATED { |
| | ms0, ms1, ms2, ms3, ms4, ms5, ms6, ms8, ms10, ms20, ms30, ms40, ms50, ms60, ms80, |
| | ms100, ms200, ms300, ms500, ms750, ms1280, ms1920, ms2560, spare9, spare8, |
| | spare7, spare6, spare5, spare4, spare3, spare2, spare1}, |
| drx-HARQ-RTT-TimerDL | INTEGER (0..56), |

...... omit

In a second possible implementation, drx-onDurationTimer is counted based on available time, and some reserved states of DRX-onDurationTimer could be used for indicated the drx-onDurationTimer based on available time. For example, 8 states in total can be used, as shown below with underlined text, where AmsX means the drx-onDurationTimer is based on X available milliseconds. That is, the DRX configuration IE includes a first list of values for the available time and a second list of values for the absolute time DRX-Config information element

-- ASN1START
-- TAG-DRX-CONFIG-START

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, ms50, ms60, |
| | ms80, ms100, ms200, ms300, ms400, ms500, ms600, ms800, ms1000, ms1200, |
| | ms1600, Ams2,Ams3, Ams4, Ams5,Ams6, Ams7, Ams10, Ams20} |
| | }, |

...... omit

In a third possible implementation, drx-onDurationTimer counted based on available time or absolute time is based on UE capability. If UE supports drx-onDurationTimer with available time, then it should report the capability to gNB.

For XR services, a large buffer will be generated, and this results in having to create buffer Status reporting (BSR) indexes higher than that in the existing BSR tables. The higher the BSR index, the larger the inaccuracy of buffer status. This is since the BSR index indicates a range of values between X and Y, and the difference between X and Y is large. An enhancement method for this issue will be needed.

FIG. 13 is a flowchart of a wireless communication method according to a fourth embodiment of the present application. Referring to FIG. 13 in conjunction with FIG. 1, the method 400 includes the following. In Step 410, the UE 10 transmits a buffer status to a base station with an index indicating a specific range of buffer size and an enhanced BSR indication indicating one of a plurality of sub-ranges of the specific range of buffer size, wherein the specific range of buffer size is divided into the plurality of sub-ranges. With this method, buffer status reporting is met for XR services.

Specifically, a new field can be introduced in Media Access Control (MAC) Control Element (CE) for BSR to provide an enhanced BSR indication. The enhanced BSR indication in the new field indicates a specific sub-range among the values from X to Y.

For instance, if the enhanced BSR indication is one bits in size, and a total number of the sub-ranges is two and each of the sub-ranges is ½ of the specific range of buffer size. Specifically, if 1 bit is introduced for BSR indication enhancement, then two states can be indicated, denoted as {0,1}. Taking index 12 in table 1 below as specified in 3GPP Rel-15/16 for example, corresponding range of this buffer status is from 277 to 384 bytes. Then, one of the two states (e.g., state “0”) can be used to indicate a range from 277 to 277+((384−277+1)/2), and the other state (e.g., state “1”) can be used to indicate a range from 277+((384−277+1)/2)+1 to 384.

TABLE 1
Buffer size levels (in bytes) for 5-bit Buffer Size field

| Index | BS value |
|---|---|
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

If the enhanced BSR indication is two bits in size, a total number of the sub-ranges is four and each of the sub-ranges is ¼ of the specific range of buffer size. Specifically, if 2 bits are introduced for BSR indication enhancement, then four states can be indicated, denoted as {00, 01, 10, 11}. Taking index 12 in table 1 above for example, corresponding range of this buffer status is from 277 to 384 bytes. Then, a first one of the four states (e.g., “00”) indicates a range from 277 to 277+((384−277+1)/4), a second one of the four states (e.g., “01”) indicates a range from 277+((384−277+1)/4)+1 to 277+2*((384−277+1)/4), a third one one of the four states (e.g., “10”) indicates a range from 277+2*((384−277+1)/4)+1 to 277+3*((384−277+1)/4), and a fourth one of the four states (e.g., “11”) indicates a range from 277+3*((384−277+1)/4)+1 to 384.

If the enhanced BSR indication is N bits in size, a total number of the plurality of the sub-ranges is 2\hat{ }N and each of the sub-ranges is 1/(2\hat{ }N) of the specific range of buffer size.

In some embodiments, the size of the new field is fixed. In some embodiments, the size of the new field can be configured by RRC signaling. In some embodiments, floor ((Y−X)/N) or Round ((Y−X)/N) can also be used for BSR indication enhancement. In some embodiments, if UE supports the enhanced BSR, then UE needs to report corresponding capability to gNB.

Commercial interests for some embodiments are as follows. 1. Solving issues in the prior art. 2. HARQ-ID is determined for XR services. 3. Latency is improved. 4. DRX-ON duration is guaranteed. 5. Buffer status reporting is met for XR services. 6. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A wireless communication method, performed by a user equipment (UE) in a network, the method comprising:
being configured with a fixed transmission pattern within a periodicity, wherein the transmission pattern comprises multiple Configured Grant (CG) configurations within the periodicity; and
determining Hybrid Automatic Repeat reQuest (HARQ)-ID of each of the CG configurations within the periodicity for estiblishing identity of each of the CG configurations for HARQ, wherein the HARQ-ID of remaining CG configurations except a first CG configuration appeared first in the periodicity is determined based on the HARQ-ID of the first CG configuration within the periodicity and one or more values of a configured, pre-configured or pre-defined setting.

2. The method of claim 1, wherein the one or more values of the setting comprises a default value, and the HARQ-ID of one of the remaining CG configurations within the periodicity is calculated based on a modulo operation performed on a sum of the default value and the HARQ-ID of a nearest CG configuration previous to said one of the remaining CG configurations.

3. The method of claim 1, wherein the one or more values of the setting comprises a set of HARQ-ID offsets, and the number of the set of HARQ-ID offsets is equal to the number of the CG configurations within the periodicity minus 1.

4. The method of claim 3, wherein the HARQ-ID of one of the remaining CG configurations within the periodicity is calculated based on a modulo operation performed on a sum of the HARQ-ID of the first CG configuration within the periodicity and a corresponding HARQ-ID offset value of the set of HARQ-ID offsets, and wherein the corresponding HARQ-ID offset value is a value corresponding to said one of the remaining CG configurations.

5. The method of claim 3, wherein there is only one HARQ-ID offset value in the set of HARQ-ID offsets or all of HARQ-ID offset values in the set of HARQ-ID offsets are identical to each other.

6. A wireless communication method, performed by a user equipment (UE) in a network, the method comprising:
being configured with Discontinuous Reception (DRX) and/or Semi-Persistent Scheduling (SPS)/Configured Grant (CG) transmission occasions;
being configured with a Physical Downlink Control Channel (PDCCH) monitor occasion after each of the SPS/CG transmission occasions; and
monitoring PDCCH on the PDCCH monitor occasion when a Physical Downlink Shared Channel (PDSCH) or Physical Uplink Shared Channel (PUSCH) is received or transmitted on a corresponding SPS/CG transmission occasion.

7. The method of claim 6, wherein the UE is configured to skip monitoring the PDCCH on the PDCCH monitor occasion during a DRX-ON state even though the PDSCH or PUSCH is received or transmitted on the corresponding SPS/CG transmission occasion.

8. The method of claim 6, wherein predefined location and resources are used for the PDCCH monitor occasion.

9. The method of claim 8, wherein the PDCCH monitor occasion is located at a slot or available slot next to each of the SPS/CG transmission occasions.

10. The method of claim 8, wherein the PDCCH monitor occasion is located at one or more slots next to each of the SPS/CG transmission occasions.

11. The method of claim 8, wherein the UE is configured with a time offset, and a location of the the PDCCH monitor occasion is within slot i plus the time offset, where the slot i is a slot on which the corresponding SPS/CG transmission occasion is located.

12. The method of claim 8, wherein the UE is configured with a time offset, and a location of the the PDCCH monitor occasion starts at symbol i plus the time offset, where the symbol i is a last symbol of the corresponding SPS/CG transmission occasion.

13. The method of claim 6, wherein configured parameters of nearest received Downlink Control Information (DCI) are reused for the PDCCH monitoring.

14. The method of claim 13, wherein the configured parameters are received before DRX configuration and are used to determine location and resources for the PDCCH monitor occasion.

15-24. (canceled)

25. A wireless communication method, performed by a base station (BS) in a network, the method comprising:
configuring a user equipment (UE) with a fixed transmission pattern within a periodicity, wherein the transmission pattern comprises multiple Configured Grant (CG) configurations within the periodicity; and
configuring or pre-configuring a setting for the UE to determine Hybrid Automatic Repeat reQuest (HARQ)-ID of each of the CG configurations within the periodicity for estiblishing identity of each of the CG configurations for HARQ, wherein the HARQ-ID of remaining CG configurations except a first CG configuration appeared first in the periodicity is determined based on the HARQ-ID of the first CG configuration within the periodicity and one or more values of the setting.

26. The method of claim 25, wherein the one or more values of the setting comprises a default value.

27. The method of claim 25, wherein the one or more values of the setting comprises a set of HARQ-ID offsets, and the number of the set of HARQ-ID offsets is equal to the number of the CG/SPS configurations within the periodicity minus 1.

28. The method of claim 27, wherein there is only one HARQ-ID offset value in the set of HARQ-ID offsets or all of HARQ-ID offset values in the set of HARQ-ID offsets are identical to each other.

29-46. (canceled)
